(19) United States
(12) Patent Application Publication
(10) Pub. No.: US 2012/0253876 A1
(43) Pub. Date: Oct. 4, 2012

(54) BENEFIT-BASED EARNED VALUE MANAGEMENT SYSTEM

(75) Inventor: Maxine Hersch, Toronto (CA)

(73) Assignee: Accenture Global Services Limited, Dublin (IE)

(21) Appl. No.: 13/434,417

(22) Filed: Mar. 29, 2012

Related U.S. Application Data
(60) Provisional application No. 61/469,429, filed on Mar. 30, 2011.

(51) Int. Cl. G06Q 10/06

(52) U.S. Cl. 705/7.17

(57) ABSTRACT

A benefit-based earned value management (BEVM) system that may store a work plan identifying tasks for completing a project, a time and cost baseline including time and cost estimates for completing the tasks and a benefits baseline including estimates of benefits and time estimates for achieving the estimated benefits over the duration of the project. The BEVM system may determine actual costs, actual time to complete the tasks, and actual benefits as the project progresses to completion and compare the metrics to the time and cost baseline and the benefits baseline to determine variances which in turn may be used to determine corrective actions and other activities that may be performed in order to improve project performance and business outcomes.

### PRIORITY

The present application claims priority to U.S. Provisional Patent Application Ser. No. 61/469,429, filed on Mar. 30, 2011, entitled “Benefit-Based Earned Value Management”, which is incorporated by reference in its entirety.

### BACKGROUND

Project management may encompass planning, organizing, securing, and managing resources to achieve specific goals. Typically, a project comprises a set of tasks to be performed within a given time period to achieve the goals and bring out a beneficial change. For example, a project may be a construction project for building commercial real estate, or an information technology (IT) project for installing new customer relationship management (CRM) enterprise software. Managing such projects may encompass determining tasks to be performed to complete the project and securing a team or multiple teams and other resources and/or materials needed to perform the tasks needed to complete the project.

In addition to planning and securing resources for the project, the project may be tracked as it progresses to determine whether it is on-budget and whether it is on track to be completed within a predetermined time allotted to complete the project. Typically, spreadsheets or project management software are used to track budget and time over-runs. However, spreadsheets or project management software that simply track budget and time provide a limited view of the progress of a project and do not provide insight on current or projected project benefits.

### SUMMARY

According to an embodiment, a benefit-based earned value management (BEVM) system includes a data storage which may store a work plan identifying tasks for completing a project, a time and cost baseline including time and cost estimates for completing the tasks and a benefits baseline including estimates of benefits and time estimates for achieving the estimated benefits over the duration of the project. A processor may interface with at least one of a user portal, an application and a data source to capture metrics including actual costs, actual time to complete the tasks, and actual benefits as the project progresses to completion and store the metrics in the data storage. The processor may compare the metrics to the time and cost baseline and the benefits baseline, determine variances from the comparisons, and generate a report providing indications of the variances.

According to another embodiment, a method of managing benefit-based earned value for a project may include storing a work plan identifying tasks for completing a project in a data structure in a data storage, storing a time and cost baseline including time and cost estimates for completing the tasks in the data structure in the data storage, storing a benefits baseline including estimates of benefits and time estimates for achieving the estimated benefits over the duration of the project in the data structure in the data storage, interfacing with at least one of a user portal, an application and a data source via a network to capture metrics including actual costs, actual time to complete the tasks, and actual benefits as the project progresses to completion, storing the metrics in the data storage, retrieving the metrics, the time and cost baseline and the benefits baseline from the data storage for a point in time prior to completion of the project, comparing the retrieved metrics to the time and cost baseline and the benefits baseline, determining variances from the comparisons, and generating a report via a graphic user interface providing indications of the variances.

One or more of the steps of the method and functions performed by the system may be embodied as machine readable instructions executable by a processor to perform a function or a method. The machine readable instructions may be stored on a non-transitory computer readable medium.

### BRIEF DESCRIPTION OF THE DRAWINGS

Embodiments are described in detail in the following description with reference to the following figures. The figures represent examples, and the embodiments are not limited by the examples in the accompanying figures in which like reference numerals indicate similar elements.

FIG. 1 shows a system architecture of a benefit-based earned value management (BEVM) system;

FIG. 2 shows a computer system that may be a platform for the BEVM system;

FIG. 3 shows modules that may be in a BEVM framework;

FIG. 4 shows a flow chart of a method for managing benefit-based earned value for a project;

FIG. 5 shows a work plan; and

FIG. 6 shows a report.

### DETAILED DESCRIPTION

For simplicity and illustrative purposes, embodiments of the invention are described by referring mainly to examples thereof. Also, numerous specific details may be set forth in order to provide a thorough understanding of the embodiments. It is apparent however, to one of ordinary skill in the art, that the embodiments may be practiced without limitation to these specific details and examples. Also, in some instances, well known methods and structures have not been described in detail so as not to unnecessarily obscure the description of the embodiments. Furthermore, different embodiments are described below. The embodiments may be used or performed together in different combinations.

According to an embodiment, a benefit-based earned value management (BEVM) system analyzes project performance. A project includes a set of tasks to be performed to achieve a final goal. The BEVM system assesses benefits of a project for its analysis of project performance rather than basing evaluation of project performance solely on schedule and budget. For example, the BEVM system uses BEVM metrics to assess a project based on benefits at any given time from start to completion of the project. BEVM metrics may also be used to assess projects even after project completion. For example, in some instances benefits, or at least some of the benefits, are not expected until a period of time after project completion. In those instances, BEVM metrics may be used to assess the project based on a post-project benefits analysis. However, unlike the situations where BEVM metrics are used for a benefits analysis during the project, the post-project benefits analysis cannot be used to affect change to improve the project results because the project is already completed. One example of a benefit-based BEVM metric is a benefit performance index (BPI). The BPI provides a way to measure the actual benefits of a project relative to the planned benefits at any point in time. The BPI may be used in project management to evaluate project performance at a given point in time, and the BPI may be based on a time-based plan for achieving specific benefits. The BPI may also be utilized in combination with earned value management (EVM) metrics, such as a schedule performance index (SPI), a cost performance index (CPI) and/or other EVM metrics. The utilization of the BPI alone, or in combination with the SPI, CPI and other EVM metrics are explained in greater detail below.

The BEVM system is operable to provide information at a practical level that summarizes benefits and earned value by tracking and monitoring and calculation of the BEVM metrics and/or EVM metrics. The BEVM system is operable to provide auto-generated alerts to project managers of potential schedule, costs, and benefits risks early and may perform prescriptive analytics to identify corrective actions based on the identified performance of the project. The BEVM system stores and generates a documented project performance trail and communicates project status and quantitative data for decision making. The BEVM system enables statistical estimation of completion costs and benefits and relates time-phased budgets to specific tasks.

The BEVM system performs analytics. The analytics may include evaluating and forecasting performance of the project and determining corrective actions or other actions that may be warranted to improve performance or satisfy other goals.

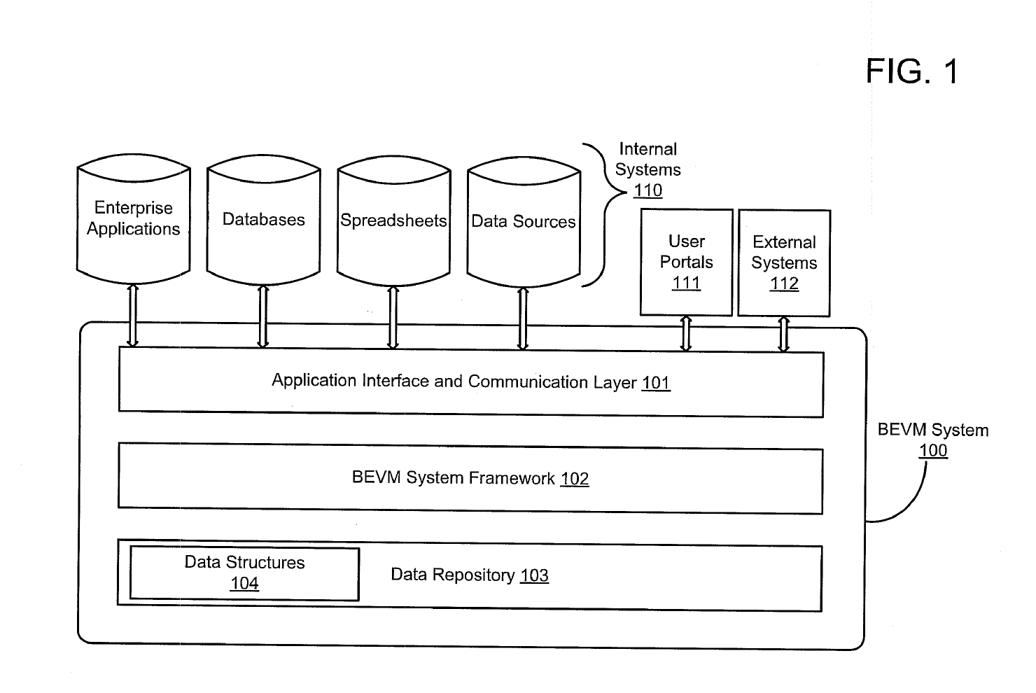

FIG. 1 illustrates an architecture for a BEVM system 100. The BEVM system may be implemented as software stored on a non-transitory computer readable medium and executed by one or more processors. The architecture shown in FIG. 1 may represent a software architecture.

The architecture includes an application interface and communication layer 101, a BEVM system framework 102 and a data repository 103. The data repository 103 is data storage that may include a database system or other type of data storage system. The application interface and communication layer 101 supports data collection from internal systems 110 of a user, which may include enterprise applications, databases, spreadsheets and other applications. The layer 101 also provides secured communication with user portals 111 and external systems and data sources 112, for example, via the Internet. The layer 101 may utilize a full-featured web services library to support secure communication for the user portals 111 and external systems and data sources 112. The user portals 111 may comprise a graphic user interface accessible via the Internet which allows users to interact with the BEVM system 100.

The layer 101 provides a mechanism for interfacing with the internal systems 110 and other data sources so the BEVM system framework 100 can quickly and easily access data to perform its function. The layer 101 provides for data collection from enterprise resources and other sources, including user input received via a user portal or other user interface for the BEVM system 100. The layer 101 may include application program interfaces (APIs) to communicate with the internal systems 110 and the systems 112. For example, the layer 101 receives data from the enterprise applications, for example, through APIs or other interfaces and may normalize the data for storage in data repository 103. Normalizing may include formatting according to predetermined schemas. For example, the layer 101 identifies types and categories or fields for data received from the internal systems 110, user portals 111 or external systems 112. The layer 101 maps the received data to schemas of tables in the data repository 103 based on the determined types and fields. Then, the data may be stored in tables in the data repository 103. The BEVM may create a data structure in the data repository 103 according to the predetermined schemas. The data structure stores the normalized data received from the data sources via layer 101. The data structure is then used to retrieve data from the data repository 103 for analysis of project performance. Multiple data structures 104 may be created and used to store and retrieve data.

Some of the information stored in the data repository 103 may include a work plan describing the tasks, resources and timeline for a project. The work plan may include a budget for the project. The normalized data and other data received from data sources and stored in the data structures 104 may include project metrics and any other information used to analyze project performance. The BEVM system 100 captures and stores this information and the BEVM system 100 determines BEVM and EVM metrics from the information. The data repository 103 may store rules for calculating metrics and performing comparisons. As indicated above, the metrics may include BEVM and EVM metrics. Although BEVM metrics and EVM metrics are generally referred to as separate metrics, the EVM metrics may be considered as a subset of the BEVM metrics. Both BEVM and EVM metrics include metrics directed to measuring and managing earned value but BEVM metrics include metrics that are benefits-based as well as the standard EVM metrics. Examples of the metrics are described below.

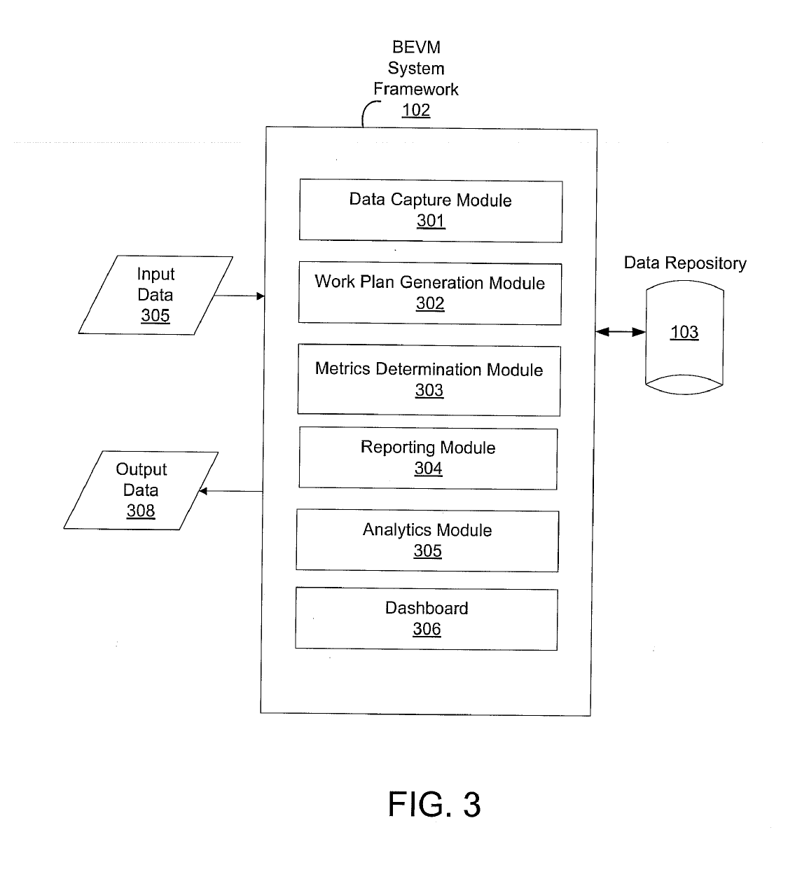

The BEVM system framework 102 performs the functions of the BEVM system 100. For example, the BEVM system framework 102 includes functions for determining the metrics, comparing metrics to the work plan, calculating earned value, analytics capabilities, reporting functions, and other functions. The BEVM system framework 102 is further described with respect to FIG. 3.

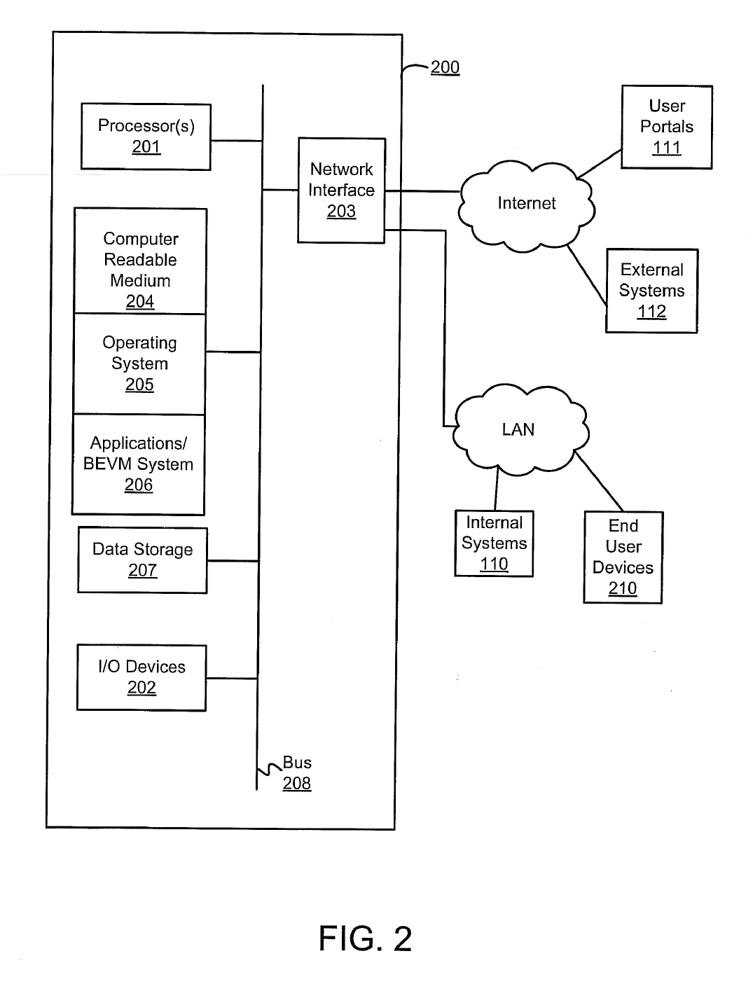

FIG. 2 illustrates a computer system 200 that may be used to implement the BEVM system 100. The computer system 200 may include additional components not shown and some of the components described may be removed and/or modified. Also, the BEVM system 100 may be implemented in a distributed computing system, such as a cloud computer system. For example, the computer system 200 may represent a server that runs the BEVM system 100 or the computer system 200 may comprise one of multiple distributed servers that performs functions of the BEVM system 100.

The computer system 200 includes processor(s) 201, such as a central processing unit, ASIC or other type of processing circuit; input/output devices 202, such as a display, mouse keyboard, etc., a network interface 203, such as a Local Area Network (LAN), a wireless 802.11x LAN, a 3G or 4G mobile WAN or a WiMax WAN, and a computer-readable medium 204. Each of these components may be operatively coupled to a bus 208. Computer readable medium 204 may be any suitable medium which stores machine readable instructions to be executed by processor(s) 201. For example, the computer readable medium 204 may be non-transitory and/or non-volatile, such as a magnetic disk or volatile media such as RAM. The instructions stored on the computer readable medium 204 may include machine readable instructions executed by the processor(s) 201 to perform the methods and functions of the BEVM system 100. The computer readable medium 204 may include solid state memory for storing machine readable instructions and/or for storing data temporarily, which may include information from the data repository, for performing project performance analysis.

The computer readable medium 204 may store an operating system 205, such as MAC OS, MS WINDOWS, UNIX, or LINUX, and one or more applications 206, which include a software application providing the BEVM system 100. The operating system 205 may be multi-user, multiprocessing, multitasking, multithreading, real-time and the like.

The computer system 200 may include a data storage 207 storing databases for the data repository 103 shown in FIG. 1 or the computer system 200 may be connected to a database server (not shown) hosting the data repository 103.

The network interface 203 connects the computer system 200 to the internal systems 110, for example, via a LAN. End user devices 210 and other computer systems/servers connected to a network, such as a LAN or WAN, may connect to the computer system 200 via the network, and the computer system 200 is connected to the network via the network interface 203. The end user devices 210 may include workstations, laptops, mobile devices, etc. Also, the network interface 203 may connect the computer system 200 to the Internet. For example, the computer system 200 may connect to user portals 111 and external systems 112 via the network interface 203 and the Internet. The user portals 111 may comprise a web interface that is accessible via the Internet by end user devices. Also, the network interface 203 may connect the computer system 200 to other computer systems, such as other servers, network storage devices, etc.

FIG. 3 shows an example of modules that perform the functions of the BEVM system 100. A module comprises machine readable instructions that are executable by a processor to perform one or more functions. The modules shown in FIG. 3 may be part of the BEVM system framework 102 shown in FIG. 1.

The BEVM system framework 102 may include a data capture module 301, a work plan generation module 302, a metrics determination module 303, a reporting module 304, an analytics module 305 and a dashboard 306. The components 301-306 provide the functionality of the BEVM system 100. The data capture module 301 captures information used by the BEVM system 100, which may include project metrics, budgetary information, work plan information, etc. The data capture module 301 may capture at least some of the information from the internal systems 110, the user portals 111, and the external systems 112 via the layer 101 shown in FIG. 1. Some information may be provided from users via the dashboard 306, which may be generated on the end user devices 210 via an internal network, such as a LAN.

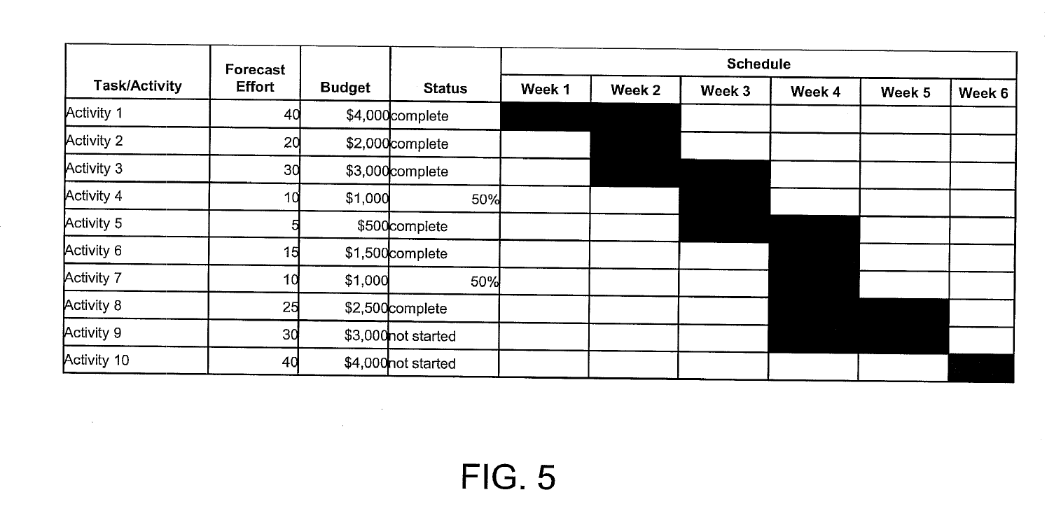

The work plan generation module 302 generates a work plan based on data provided by the user. The work plan may include a description of the tasks for the project, resources, timeline, budget and/or other metrics for a project. Examples of information that may be included in a work plan are shown in FIG. 5 and are described in further detail below. The work plan generation module 302 may organize information provided by a user into a work plan, such as in a grid format shown in FIG. 5, and updates the work plan as the project progresses. The updates may include indications of tasks completed and other updates.

The metrics determination module 303 determines values for metrics used for analyzing project performance. Examples of the metrics are described in further detail below. The metrics may include BEVM and EVM metrics. Some of the metrics may be selected by a user via the dashboard 306 and some metrics may be calculated by the metrics determination module 303 based on other metrics and values determined by the data capture module 301.

The reporting module 304 generates reports, and examples of the reports are described in further detail below. The reports indicate project performance at a specified point in time of the project. For example, the user may specify a point in time prior to completion of the project, and the report module generates reports describing project performance at that time. The reports may include metrics determined by the metrics determination module 303. The reports may include trend analysis indicating how the project is trending according to budget, schedule and benefits. The reports may include output of the analytics module 305, such as suggested corrective actions to improve project performance.

The analytics module 305 for example forecasts trends, such as how the project is trending according to budget, schedule and benefits. The analytics module 305 may also use rule-based analysis to identify corrective actions based on current and/or forecasted performance of the project. For example, the analytics module 305 may compare metrics to thresholds to identify trends suggesting lower or higher benefits, lower or higher costs, or whether the project is tracking as late, early or on-time with respect to the schedule in the work plan. Other metrics may also be considered, such as quality or other metrics. Based on the comparisons, the analytics module 305 may suggest actions to be performed, such as adding more resources to a project to get the schedule on track if it is under budget, or diverting resources to other projects if the project is ahead of schedule. Rules stored in the data repository 103 may specify thresholds and suggested actions to perform if certain conditions are met.

The dashboard 306 may comprise a graphic user interface for users to interface with the BEVM system 100. The users may enter data into the BEVM system 100 and view reports and other information via the dashboard 306.

The BEVM system 100 receives input data 305 which may include parameters for the work plan, budget and other information including estimated and actual benefits and costs. The input data 305 may include data from the internal systems 110, from users and the external systems 112. The output data 308 may include reports generated by the reporting module 304 or other information generated by the BEVM system 100. Although not shown, input data 305 and output date 308 may be communicated via layer 101 shown in FIG. 1.

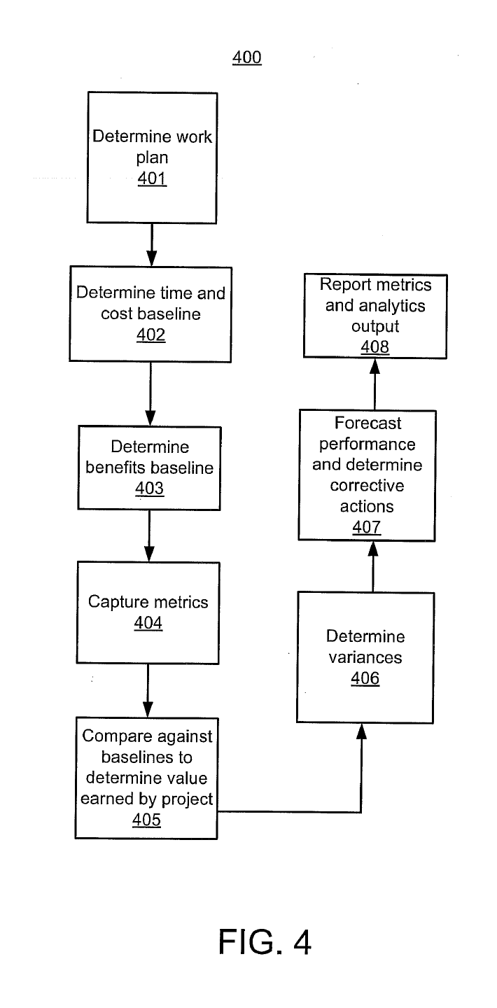

FIG. 4 illustrates a method 400 for evaluating earned value for a project. The method 400 may be performed by the BEVM system 100 according to an embodiment. At 401, a work plan is determined for the project. The work plan describes the tasks to be completed to complete the project. The work plan may also include the resources needed to complete the tasks and other information. The work plan generation module 302 shown in FIG. 3 may receive the tasks as user input and organize the tasks in a timeline order dependent on when the tasks need to be completed. The work plan generation module 302 stores the work plan in the data repository 103 and assigns a project ID to the work plan and associated data.

At 402, a time and cost baseline is determined for completing the project. The baseline includes time estimates for completing the tasks in the work plan and cost estimates for completing the tasks. The baseline may be included in the work plan. A time estimate may include an estimated amount of time to complete a task. A cost estimate may include an estimated monetary cost to complete a task. A schedule (e.g., a timeline) to complete the tasks and the project may be determined from the time estimates, and a budget for completing the tasks and the project may be determined from the cost estimates. A cost and completion time may be estimated for each task or for a group of tasks. For example, a cost and time estimate may be determined for each phase of a project and each phase may comprise multiple tasks. Cost and time estimates may be determined for periodic time periods, such as weekly, monthly, quarterly, yearly, etc.

At 403, a benefits baseline is determined. The benefits baseline may include estimates of benefits and time estimates for achieving the estimated benefits over the duration of the project. The benefits baseline may be included in the work plan. In one example, a benefit is something that is intended to add value in terms of business outcomes. Time estimates for achieving the benefits may include periodic times, such as weekly, monthly, quarterly and the benefits estimates may include estimates of benefit values achieved at the periodic times. Time estimates may be determined by project phase or by other intervals. Certain metrics may be used to ascertain benefits as is further described below.

Determining the benefits may include determining measurable benefits that may be associated with outcomes that reflect the success of a business and the project. The measurable benefits are the benefits metrics, which may be included in the BEVM metrics. Some examples of benefits metrics may include profits ($), sales ($), products produced (#), customers (#), quality (%), and brand recognition (%). An increase in these metrics may represent a positive benefit to the business. Other examples of benefits metrics may include costs ($), materials (lbs), labor (hrs), delivery time (hrs), days on shelf/inventory (#), and errors/complaints (#). A decrease in these metrics may represent a positive benefit to the business. Although not required, in one example, units for the metrics may be converted to a monetary value if not already in a monetary value using established conversion principles (e.g., standard rate per hour for labor, etc.), prior to comparing benefits.

Determining the benefits at 403 may include estimating values for the benefits that are achieved at estimated times of the project. For example, an example of an estimated benefit may include rental income that can be collected each quarter in a multi-phase apartment construction project. The baseline may include an estimate of rental income at various times throughout the project, such as quarterly or at different phases of the project. The estimates may represent an increase in revenue as more apartments are completed and rented.

Estimates for the baselines determined at 402 and 403 may be provided by a user and subsequently adjusted by a user. However, a controlled process may be performed to adjust either baseline. The controlled process may include getting predetermined approvals from one or more predefined individuals to modify the baseline and then modifying the baseline and associated metrics. Baseline modifications may include adjustments to the estimated costs (e.g., budget modifications), modifications to the estimated time to complete tasks (e.g., schedule modifications) and modifications to the benefits and time estimates for the benefits. Also, the work plan generation module 302 may receive the baselines from a user and store the baselines with the work plan in the data repository 103. After a change to a project has been approved, the project baselines for schedule, cost or benefits may be adjusted to include the changes. This allows for all subsequent reporting of BEVM metrics to account for the approved changes. If a change is implemented in a project without change control approval and the baselines are not adjusted, a reporting of a BEVM metric may not reflect meaningful information by which to evaluate the project's performance. A variance explanation for a metric that indicates a change to a project may flag that the project has not followed proper change control.

At 404, as the project progresses from start to finish, metrics are captured to compare against the baselines determined at steps 402 and 403. The metrics may include actual costs, actual time to complete tasks, actual benefits derived and other metrics described at 402 and 403. The data capture module 301 shown in FIG. 3 may interface with applications and user interfaces to capture the metrics and store the metrics in the data repository 103.

At 405, the metrics captured at 404 are compared against the baselines determined at 402 and 403. The comparisons provide an indication of the value earned by a project relative to the project's baselines at a given point in time. Determining the comparisons may include calculating BEVM and EVM metrics from the values determined at 404, such as the actual costs and time to complete the tasks. The BEVM metrics may include the BPI, which may be based on a combination of planned value (PV) or planned benefits (PB), earned value (EV) or actual benefits (AB), actual cost (AC) and planned cost (PC) or budget at completion (BAC). EVM metrics may include cost variance (CV), schedule variance (SV), cost performance index (CPI), schedule perform index (SPI), estimate at completion (EAC), estimate to complete (ETC) and variance at completion (VAC). A description of examples of the BEVM and the EVM metrics is provided below. The metrics determination module 303 shown in FIG. 3 may determine the BEVM and EVM metrics and perform the comparisons and store the results in the data repository 103.

At 406, variances are determined from the comparisons. The variances may include variances between the estimates in the baselines and the actual metrics. The variances may be measured by the BPI, CV, SV, BV and other calculated metrics. For example, variances may be determined by comparison of one or more of the metrics to baseline thresholds. BV is a benefits variance which may be calculated as BV=AB−PB. Calculations for other metrics are described below.

At 407, analytics are performed to estimate future performance of the project and may be used to generate prescriptive remedies if the estimated future performance is below the baseline or to generate recommended actions if the estimated future performance is above the baseline. One example of recommended actions if estimated future performance is above the baseline includes authorizing overtime to increase production because the benefits are projected to exceed the baseline expectations sufficiently to pay for the additional cost. Forecasts of future performance estimates may include determining trends, for example, by extrapolating curves representing actual metrics for benefits, costs, scheduling, etc. Variances may be determined between the actual metrics and the estimations. The prescriptive remedies may include determining corrective actions or other recommended actions based on the variances and comparisons performed at 405. The analytics may be performed by the analytics module 305 and are described in further detail below.

At 408, reporting is performed to report metrics, the results of the comparison, the results of the analytics and/or other information that is pertinent to project performance. Reporting may include reporting of differences between the baseline and actual cost and time estimates, reporting of differences between estimated benefits and actual benefits, etc. Reporting may include generating alerts based on identified variances exceeding thresholds. Reporting may be performed by the reporting module 304 shown in FIG. 3. BPI and other metrics may be determined any time up to completion, or at completion, or even after completion of the project and may be compared to the baseline so long as the baseline extends to the point in time for the comparison. Variances may be determined for the designated point in time and reporting may be performed for that point in time. Reporting may be done based on actuals for any timeframe up to and including present day so long as the baseline extends to that point in time for comparison. For points beyond the current point in time, variances may be estimated based on historical trends or other information.

Examples of metrics determined at 402-405 of the method 400 are now described in further detail. The BEVM metrics may be based on one or more of BPI, PB, AB, PV, EV, AC and BAC. BPI is described below. PB is the originally estimated benefits to be achieved by a certain date. AB is the actual benefits achieved by that date. PV is the originally estimated value of work planned to be accomplished by that date, and EV is the originally estimated value of the work actually accomplished by that date. PV and EV are calculated as a function of work and time. AC is the actual cost incurred for the work completed. AC should be based on the same date as PV and EV for determining CPI and SPI. BAC is the original budget for the completion of the entire project.

In a simplistic example, the project is a fence building project to create a 4-sided fenced-in area and each side is of equal length. The time and cost baseline estimates indicate that each side will take one day to complete and the estimated cost is $2000.00 per side. The planned value as a function of time is $2000.00 per day.

In this case, the planned value happens to be equivalent to the estimated cost per day. However, the planned value is not always equal to the estimated cost. For example, in a condo conversion project that converts apartments to condos, the planned value may not be equal to cost to convert each apartment. Instead, the planned value may be a function of estimated sale price after a sale.

Continuing with the example of the fence building project, assume that three days are completed from the start of the project. It is determined that 2.5 sides of the fencing are complete at the end of the third day. At the end of the third day, the AC is $4500.00, the PV is $6000.00, and the EV is $5000.00 (e.g., $2000 per side×2.5 sides). The BAC is $8000.00.

CV is the difference between EV and AC; CV=EV−AC. A positive CV indicates the project is under budget and a negative CV indicates the project is over budget. SV is the difference between EV and PV; SV=EV−PV. A positive SV indicates the project is ahead of schedule and a negative SV indicates the project is behind schedule. SPI is a measure of scheduled efficiency of a project expressed as a ratio of EV to PV; SPI=EV/PV. An SPI less than 1 indicates the project is behind schedule and an SPI greater than 1 indicates the project is ahead of schedule. If the project continues at an SPI value less than 1, it will deliver late. CPI is a measure of cost efficiency of a project expressed as a ratio of EV to AC; CPI=EV/AC. A CPI greater than 1 indicates the project is under budget, and a CPI less than 1 indicates the project is over budget. Continuing with the example of the fence building project, and assuming that three days are completed from the start of the project, CV=$500.00 (project is under budget); SV=−$1000.00 (project is behind schedule); SPI=0.83 (project is behind schedule); and CPI=1.11 (project is under budget).

EAC is how much completion of the total project is expected to cost.

The EAC may be calculated based upon how the project has been performing. Four examples of calculations that may be utilized to calculate the EAC are as follows: 1. EAC=AC+ETC (actual cost plus an estimate for remaining work; this may be used when an original estimate is undesirable or erroneous); 2. EAC=BAC/CPI (this may be used if a project is expected to continue at the same rate of spending); 3. EAC=AC+(BAC−EV) (actual cost plus remaining budget; this calculation may be used when current variances are estimated to be atypical); and 4. EAC=AC+(BAC−EV)/CPI (actual cost to date plus remaining budget modified by performance). Estimate to Complete (ETC) is how much additional costs are expected to finish the project. For greater accuracy, ETC may not be calculated as BAC-AC, and instead is calculated as ETC=EAC−AC. Variance at Completion (VAC) is how much over or under budget the project is currently projected to be at the end of a project; VAC=BAC−EAC.

The BPI is a measure of benefits realization on a project and may be expressed as a ratio of Actual Benefits (AB) to Planned Benefits (PB); BPI=AB/PB. A BPI value of greater than 1 indicates that the work has achieved greater benefits (e.g. cost savings) than planned at the designated point in time of the calculation. A BPI value of less than 1 indicates that the work has achieved less benefits than expected at that point in time. It should be noted that some projects may not achieve any benefits until after they are complete. Others may begin to achieve benefits early in their deployment phase. BPI is not a standard measurement found in traditional earned value metrics. It is an additional metric found only in BEVM and its use enables BEVM metrics to project performance against a business case.

The PB may be part of the benefits baseline determined at step 403 of the method 400. The AB may be based on captured metrics determined at step 404. The PB may be calculated from a single benefits metric or a plurality of benefits metrics. For example, a benefits metric may be sales. PB may be an estimate of sales achieved during the project. In another example, PB is calculated as a function of sales and goodwill. Goodwill may be converted to a dollar amount based on a conversion factor and the sales and goodwill values are combined according to function, such as averaged, totaled, etc., to derive the PB. The AB is then calculated using the same function but based on actual values, such as actual sales and goodwill achieved as measured at a given point in time during the project.

The BPI is further described with respect to a new fence building project example. In this example, the project is to build a three-plot fenced enclosure. Each plot is enclosed by four equal sides, and adjacent plots share a side. The enclosures are to be completed sequentially. The estimate to build the fence indicates that each side will take 1 day to build and is budgeted for $2000.00 per side. As soon as each plot is complete it can be rented for pasture for $1000.00. After seven days, the first plot is enclosed and two additional sides of the second enclosure are completed. Thus, one remaining side of the second enclosure is not completed and all the sides for the third enclosure are not completed.

In this example, after seven days, only one enclosure is completed and that enclosure is rented. The AB after seven days is $1000.00 as one plot is completely enclosed and is rented. The PB is $2000.00 as it was planned that two plots would be completed and rented by this time. BPI=AB/PB=1000/2000=0.5. The BPI is less than 1 indicating that work has achieved fewer benefits than planned at this point in the schedule.

The analytics module 305 shown in FIG. 3 uses the BEVM metrics as a guide for prescriptive analytics. The analytics module 305 determines actions to be performed to manage or correct project performance. The analytics module 305 may use multiple BEVM metrics to identify corrective actions.

Opportunities to correct project performance vary depending upon the interactions of schedule, cost and benefits. For example, the analytics module 305 considers multiple factors when determining corrective actions. The factors may be based on the BEVM and EVM metrics. The factors may include whether a project budget is being used efficiently; whether a schedule is on track or ahead of schedule if the SPI is close to 1; whether or not the expected benefits have been realized, etc. Also, thresholds for the metrics may be used to trigger identification of corrective actions. For example, the budget is determined as not being used efficiently if the CPI is less than 0.9. This may trigger analysis as to how to improve the performance of the project. The analytics module 305, at this point, seeks opportunities to lower costs, such as replacing an expensive resource, i.e., $200/hour with a cheaper resource $100/hour. In this example this may be a good solution. However, the analytics module 305 also determines if the cheaper resource is less efficient, e.g., is less experienced so it takes longer such as a 1.5 hour increase in time. In this example, if project performance is ahead of schedule, and the increased time does not impact the schedule, then the analytics module 305 may determine the difference in cost between the resources may be an acceptable solution. When devising corrective actions, the analytics module 305 may evaluate the impacts to all the project attributes such as cost, schedule, scope, quality, safety, etc. In the example above, the cheaper resource corrects the budget issue without negatively impacting the schedule and thus is determined to be an acceptable solution. However, if the analytics module 305 estimates that quality of the project would suffer, the analytics module 305 may identify other corrective actions in addition to or in place of replacing the resource as described above. An advantage of the BEVM system 100 is that, while it may integrate cost, schedule and budget, it also may evaluate quality or other performance areas of a project. The addition of BPI and other BEVM metrics enables this dimension of analysis.

In the first fence building example, EV=$5000; AC=$4500; PV=$6000; CPI=EV/AC=$5000/$4500=1.11; and SPI=EV/PV=5000/$6000=0.83. The analytics module 305 determines that as it is being performed, the project is likely to be delivered late as indicated by the SPI (<1), however this project is performing under budget (CPI>1). Based on this combination of a SPI<1 and a CPI>1, the analytics module 305 suggests a corrective action that includes adding resources until the project is back on track with its schedule because additional resources can be absorbed while staying within the budget.

FIG. 5 illustrates another example of utilizing BEVM metrics for analytics. FIG. 5 discloses an example of a work plan including tasks for a project, forecast effort (a measure of effort needed to complete a task), budget, status, and schedule for the project. A work plan may include at least some of this information or other information. The BEVM system 100 may determine that at the end of the fifth week of execution for the project, the actual cost is $12,000.00, the actual benefits are $7,000.00, and the planned benefits are $10,000.00. Given the information contained in the work plan shown in FIG. 5, the metrics determination module 303 shown in FIG. 3 calculates the EV, PV, SPI, CPI and BPI as follows:

EV=4000+2000+3000+(1000*50%)+500+1500+(1000*50%)+2500+(3000*0%)=$14,500.00;

PV=4000+2000+3000+1000+500+1500+1000+2500+3000=$18,500.00.

SPI=EV/PV=14,500/18,500=0.78, and this indicates that the project is currently behind schedule. CPI=EV/AC=14500/12000=1.2, and this indicates that the project is currently under budget. BPI=AB/PB=7000/10000=0.7, and this indicates that the project is currently achieving less benefits than planned.

The analytics module 305 determines that this project is likely to be delivered late as indicated by the SPI (<1), and that this project is currently performing under budget (CPI>1). The analytics module 305 may suggest adding resources to bring the schedule back on track while remaining within budget. However, the BPI<1 indicates that the anticipated benefits have not been achieved, so the analytics module 305 may suggest to continue as is and deliver the project late, and use the leftover budget to offset reduced benefits. The analytics module 305 may consider the cause of each variance to determine appropriate action.

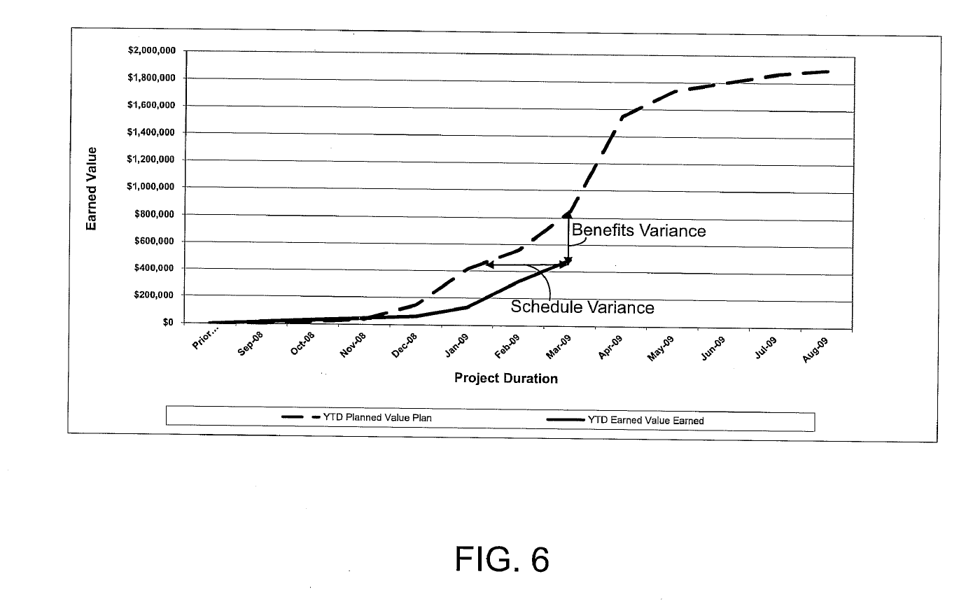

FIG. 6 illustrates an example of some of the variances that may be determined by the BEVM system 100. Also, FIG. 6 shows an example of a report that may be generated by the BEVM system 100 showing the variances. The variances shown are benefits and schedule variances. A cost variance may be similarly illustrated in graphs. Also, the YTD earned value curve represents the measured actual metrics and the YTD planned value represents the estimated metrics, for example, from the baselines. The YTD earned value curve may be extrapolated to future time periods up to completion of the project based on trends in the variances. The trends and extrapolations may be used to select prescriptive actions.

While the embodiments have been described with reference to the disclosure above, those skilled in the art are able to make various modifications to the described examples without departing from the scope of the embodiments as described in the following claims, and their equivalents.

What is claimed is:

1. A benefit-based earned value management (BEVM) system comprising:
a data storage to store a work plan identifying tasks for completing a project, a time and cost baseline including time and cost estimates for completing the tasks and a benefits baseline including estimates of benefits and time estimates for achieving the estimated benefits over the duration of the project;
a processor to
interface with at least one of a user portal, an application and a data source to capture metrics including actual costs, actual time to complete the tasks, and actual benefits as the project progresses to completion and store the metrics in the data storage;
compare the metrics to the time and cost baseline and the benefits baseline;
determine variances from the comparisons; and
generate a report providing indications of the variances.

2. The BEVM system of claim 1, wherein the processor is to determine a planned benefit from the benefits baseline and determine an actual benefit from the captured metrics and calculate a benefits performance index, wherein the benefits performance index is calculated as a function of the planned benefit and the actual benefit.

3. The BEVM system of claim 2, wherein the benefits performance index is the actual benefit divided by the planned benefit.

4. The BEVM system of claim 1, wherein the processor is to calculate a benefits performance index that is a measure of benefits realization on the project at a point in time during the project prior to completion.

5. The BEVM system of claim 1, wherein the processor is to compare the variances to thresholds to determine performance of the project according to benefits, cost and time, and to determine a prescriptive action to perform based on the comparison of the variances to thresholds.

6. The BEVM system of claim 5, wherein the processor comparing the variances to thresholds comprises the processor calculating a benefits performance index that is a measure of benefits realization on the project at a point in time during the project prior to completion, and if the benefits performance index is less than 1 the processor determines benefits of the project are less than expected and if the benefits performance index is greater than 1 the processor determines the benefits of the project are greater than expected, wherein the benefits determination is used to determine the prescriptive action.

7. The BEVM system of claim 6, wherein the processor comparing the variances to thresholds comprises the processor calculating a schedule performance index that is a measure of whether the project is on schedule at the point in time, and if the schedule performance index is less than 1 the processor determines the project is behind schedule, and if the schedule performance index is greater than 1 the processor determines the project is ahead of schedule, wherein the schedule determination based on the schedule performance index is used to determine the prescriptive action.

8. The BEVM system of claim 7, wherein the processor comparing the variances to thresholds comprises the processor calculating a cost performance index that is a measure of whether the project is on budget at the point in time, and if the cost performance index is less than 1 the processor determines the project is over budget, and if the cost performance index is greater than 1 the processor determines the project is under budget, wherein the budget determination cost performance index is used to determine the prescriptive action.

9. The BEVM system of claim 1, further comprising an application interface and communication layer providing the interface between a BEVM system framework and the user portal, the application and the data source via a network.

10. The BEVM system of claim 1, wherein the processor stores information in data structures in the data storage, wherein the data structures have predetermined schemas.

11. A method of managing benefit-based earned value for a project, the method comprising:
storing a work plan identifying tasks for completing a project in a data structure in a data storage;
storing a time and cost baseline including time and cost estimates for completing the tasks in the data structure in the data storage;
storing a benefits baseline including estimates of benefits and time estimates for achieving the estimated benefits over the duration of the project in the data structure in the data storage;
interfacing with at least one of a user portal, an application and a data source via a network to capture metrics including actual costs, actual time to complete the tasks, and actual benefits as the project progresses to completion;
storing the metrics in the data storage;
retrieving the metrics, the time and cost baseline and the benefits baseline from the data storage for a point in time prior to completion of the project;
comparing, by a processor, the retrieved metrics to the time and cost baseline and the benefits baseline;
determining variances from the comparisons; and
generating a report via a graphic user interface providing indications of the variances.

12. The method of claim 11, comprising:
determining a planned benefit from the benefits baseline;
determining an actual benefit from the captured metrics; and
calculating a benefits performance index for one of the variances, wherein the benefits performance index is calculated as a function of the planned benefit and the actual benefit.

13. The method of claim 11, wherein the benefits performance index is the actual benefit divided by the planned benefit.

14. The method of claim 11, comprising calculating a benefits performance index that is a measure of benefits realization on the project at the point in time.

15. The method of claim 11, comprising comparing the variances to thresholds to determine performance of the project according to benefits, cost and time, and determining a prescriptive action to perform based on the comparison of the variances to thresholds.

16. The method of claim 15, wherein comparing the variances to thresholds comprises calculating a benefits performance index that is a measure of benefits realization on the project at the point in time, and if the benefits performance index is less than 1 determining benefits of the project are less than expected and if the benefits performance index is greater than 1 determining the benefits of the project are greater than expected, wherein the benefits determination is used to determine the prescriptive action.

17. The method of claim 16, wherein comparing the variances to thresholds comprises calculating a schedule performance index that is a measure of whether the project is on schedule at the point in time, and if the schedule performance index is less than 1 determining the project is behind schedule, and if the schedule performance index is greater than 1 determining the project is ahead of schedule, wherein the schedule determination based on the schedule performance index is used to determine the prescriptive action.

18. The method of claim 17, wherein comparing the variances to thresholds comprises calculating a cost performance index that is a measure of whether the project is on budget at the point in time, and if the cost performance index is less than 1 determining the project is over budget, and if the cost performance index is greater than 1 determining the project is under budget, wherein the budget determination cost performance index is used to determine the prescriptive action.

19. A non-transitory computer readable medium storing computer readable instructions that when executed by a processor performs operations comprising:
storing a work plan identifying tasks for completing a project in a data structure in a data storage;
storing a time and cost baseline including time and cost estimates for completing the tasks in the data structure in the data storage;
storing a benefits baseline including estimates of benefits and time estimates for achieving the estimated benefits over the duration of the project in the data structure in the data storage;
interfacing with at least one of a user portal, an application and a data source via a network to capture metrics including actual costs, actual time to complete the tasks, and actual benefits as the project progresses to completion;
storing the metrics in the data storage;
retrieving the metrics, the time and cost baseline and the benefits baseline from the data storage for a point in time prior to completion of the project;
comparing the retrieved metrics to the time and cost baseline and the benefits baseline;
determining variances from the comparisons; and
generating a report via a graphic user interface providing indications of the variances.

20. The non-transitory computer readable medium of claim 19, wherein the operations comprise:
determining a planned benefit from the benefits baseline;
determining an actual benefit from the captured metrics; and
calculating a benefits performance index, wherein the benefits performance index is calculated as a function of the planned benefit and the actual benefit.
